(19) United States
(12) Patent Application Publication
(10) Pub. No.: US 2013/0137460 A1
(43) Pub. Date: May 30, 2013

(54) Correlation of Collected Mobile Terminal Based Measurement Data and Positioning Data

(71) Applicants: Gyula Bodog, Budapest (HU); Malgorzata Tomala, Nowe Miasto nad Pilica (PL)

(72) Inventors: Gyula Bodog, Budapest (HU); Malgorzata Tomala, Nowe Miasto nad Pilica (PL)

(73) Assignee: Nokia Siemens Networks Oy, Espoo (FI)

(21) Appl. No.: 13/704,766

(22) PCT Filed: Jun. 18, 2010
(86) PCT No.: PCT/EP2010/058638

§ 371 Date: Feb. 7, 2013

(51) Int. Cl. H04W 4/02

(52) U.S. Cl. CPC H04W 4/025
USPC 455/456.2; 455/456.6

(57) ABSTRACT

A network control element receives position information data including a trace session identification parameter, the position information data including information about the position of a mobile terminal, and measurement data including the trace session identification parameter are received. The position information data is correlated with the measurement data based on the trace session identification parameter.

### FIELD OF THE INVENTION

The present invention relates to apparatuses, methods and a computer program product for correlation of collected mobile terminal based measurement data (e.g., data collected in minimization of drive tests (MDT)) and positioning data.

### RELATED BACKGROUND ART

The following meanings for the abbreviations used in this specification apply:

3GPP 3rd generation partnership project

DM Domain manager

ECGI E-UTRAN Cell Global Identifier

EM Element manager

eNode-B LTE base station (also referred to as eNB)

E-SMLC Evolved service mobile location centre

E-UTRAN Evolved universal terrestrial radio access

GNSS Global navigation satellite systems

GPS Global positioning system

IMEI International mobile equipment entity

IMSI International mobile subscriber identity

LPP LTE Positioning Protocol

LTE Long term evolution

LTE-A LTE-Advanced

MSISDN Mobile station integrated services data network

MDT Minimisation of drive test

RF Radio frequency

RNC Radio network controller

RRC Radio resource control

SMLC Service mobile location centre

TR Trace reference

TRSR Trace recording session reference

UE User equipment

UMTS Universal mobile telecommunications system

Embodiments of the present invention relate to the LTE and

UMTS environment, more particularly to components such as user equipments (UE) and positioning servers such as evolved service mobile location centers (E-SMLC).

Moreover, embodiments relate to minimization of drive tests (MDT). In detail, drive tests are carried out on operator's need basis, when necessary, for example in order to optimize coverage in a network. In such drive tests, pre-configured UEs collect periodic and/or event triggered measurements and report them to the network. In order to reduce the number of drive tests, the above MDT is used.

The key information in measurements defined for minimization of drive tests (MDT) is terminal's physical location. Location information delivered together with radio signal measurements provides overall coverage picture of a network, where MDT sessions are scheduled. Thus, in 3GPP discussions on MDT feature Operators are pushing for accurate positioning information associated with MDT data. The current assumption in 3GPP RAN2 is that a best effort location information is used for MDT logs. Thus, the need for very accurate positioning is continuously requested by operators and becomes more urgent.

The main problem is that the best effort location information (ECGI, GNSS information, including from stand-alone GNSS receiver in the UE or RF fingerprints information i.e. measurement on serving/neighbor cells) is relying on non-guaranteed information that a UE and network can provide at the moment of MDT measurement. There can be cases when very accurate location information may not be provided, e.g. in cell edge area. Instead, rough estimation may be provided only. Lacking accurate location information associated with the MDT log will make the MDT feature less usable from Operator point of view.

In order to solve the problem, there are proposals to use a core network triggered positioning via the positioning server which triggers the UE to do positioning (via e.g. GPS capability).

The positioning data and the MDT data log then will be correlated in a post-processing system. However, the correlation can only be done based on certain timestamp. This raises a problem in that the time information might not be accurate, and also the correlation based on time stamp can be more power consuming.

### SUMMARY OF THE INVENTION

Thus, it is an object of the present invention to overcome the above problem of the prior art.

According to an aspect of the present invention, this is accomplished by an apparatus and a method, by which a position request including a trace session identification parameter is received, positioning of the apparatus (e.g., mobile terminal) is carried out and measurement data is collected in response to the received position request including the trace session identification parameter, and the measurement data and positioning data including the trace session identification parameter are sent.

According to a further aspect, an apparatus and a method are provided, in which a trace activation request including a trace session identification parameter is received, a position request for a mobile terminal is generated, and the position request is sent to the mobile terminal with the trace session identification parameter.

According to a further aspect, an apparatus and a method are provided, in which position information data comprising a trace session identification parameter, the position information data including information about the position of a mobile terminal, and measurement data comprising the trace session identification parameter are received, and the position information data is correlated with the measurement data based on the trace session identification parameter.

According to a further aspect, a trace session activation request for collecting mobile terminal based measurement data is generated, and the trace session activation request including a trace session identification parameter is sent to a positioning server.

### BRIEF DESCRIPTION OF THE DRAWINGS

These and other objects, features, details and advantages will become more fully apparent from the following detailed description of embodiments of the present invention which is to be taken in conjunction with the appended drawings, in which:

FIG. 1A to 1D show network elements involved in the processes according to the embodiments of the present invention.

FIG. 2 shows a signaling diagram according to an embodiment of the present invention;

FIG. 3 shows a signaling diagram according to a second embodiment of the present invention.

### DETAILED DESCRIPTION OF EMBODIMENTS

In the following, description will be made to embodiments of the present invention. It is to be understood, however, that the description is given by way of example only, and that the described embodiments are by no means to be understood as limiting the present invention thereto.

According to several embodiments of the present invention, a way of coordinating UE data and position data is introduced in order to accurately correlate or associate the minimization drive test (MDT) measurements collected by the UE (and reported to O&M via eNB/RNC) and the position estimate reported by the UE (or position estimate calculated by the E-SMLC based on position measurement reported by the UE).

This is done through an extension of the trace functionality, as will be explained in the following. The E-SMLC manages the co-ordination for the location of a UE, interacts with the UE and calculates the final location. Trace activation is targeted to the positioning server for a certain IMEI(SV)/IMSI number or MSISDN. The UE will get the trace reference and trace recording session reference, which will report together with the positioning and MDT data. When the positioning data and the MDT data are forwarded to a centralized trace collection entity (TCE), the data correlation can be done easily using the trace reference and trace recording session reference parameters.

In more detail, during the trace activation the positioning server (e.g., SMLC or E-SMLC) gets the trace reference (TR), which identifies the trace session that is used also when MDT is configured to the UE.

When the positioning server initiates the positioning to the UE via e.g. the LPP protocol in E-UTRAN, it should send the trace reference and shall allocate a trace recording session reference for the positioning request.

The UE will get the trace reference and trace recording session reference which it should report together with the positioning data and also the MDT data.

Hence, as mentioned above, when the positioning data and the MDT data are forwarded to the centralized trace collection entity, the data correlation can be done easily using the trace reference and trace recording session reference parameters.

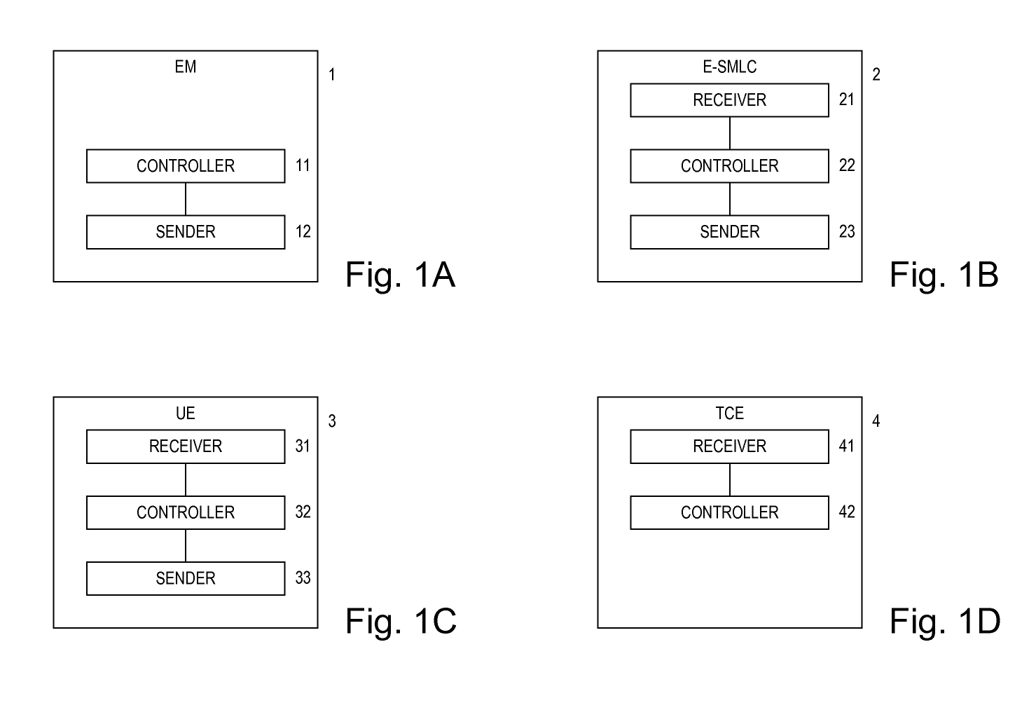

In the following, network elements involved are described by referring to FIGS. 1A to 1D.

FIG. 1A shows an apparatus 1, which may be or may be part of a network control element configuring and managing performance measurements in a network. For example, such a network control element may be an element manager (EM) or a domain manager (DM). The apparatus (in this example, a element management (EM)) 1 comprises a controller 11 which generates a trace activation request for collecting measurement data (mobile terminal based measurement data, e.g., MDT as described above), and a sender 12 which sends the trace activation request including trace session identification parameter. The trace session identification parameter may be a trace reference (TR), for example.

FIG. 1B shows an apparatus 2, for example a positioning server (e.g., SMLC or E-SMLC, as described above) which comprises a receiver 21 which receives a trace activation request including a trace session identification parameter (e.g., trace reference (TR) as described above), a controller 22 configured to generate a position request for a user equipment (UE) as an example for a mobile terminal, and a sender 23 which sends the position request to the UE including the trace session identification parameter.

FIG. 1C shows an apparatus 3, which may be or may be included in a user equipment (UE), for example. The apparatus 3 comprises a receiver 31 which receives a position request including a trace session identification parameter (e.g., trace reference (TR) and/or trace recording session reference (TRSR) as described above), a controller 32 which performs positioning of the apparatus 3 and collects measurement data for measuring e.g. radio coverage of a network (MDT data as described above) in response to the received position request including the trace session identification parameter, and a sender 33 which sends the measurement data and positioning data including the measurement identification parameter.

FIG. 1D shows an apparatus 4, which may be or may be included in a trace collection entity (TCE). The apparatus 4 comprises a receiver 41 which receives position information data comprising a trace session identification parameter, the position information data including information about the position of a mobile terminal (e.g., user equipment (UE)) and measurement data (MDT data) comprising the trace session identification parameter, the measurement data comprising information about, e.g., the coverage of a network collected by UE, and a controller 42 which correlates the position information data with the measurement data (MDT data) based on the trace session identification parameter.

It is noted that according to the above examples, the apparatuses 1 and 4 are described as separate elements. However, alternatively the apparatuses 1 and 4 could also be combined to one single entity, since apparatuses 1 and 4 are both in the O&M domain. For example, both apparatuses 1 and 4 could be incorporated in suitable network management element for operation and maintenance (O&M or OAM).

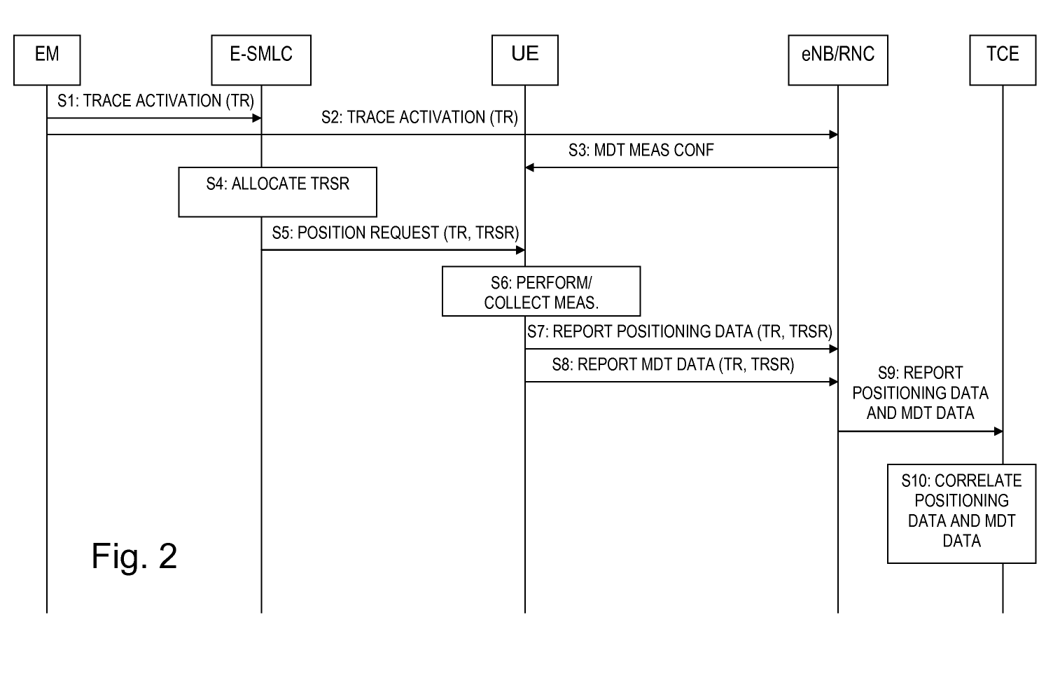

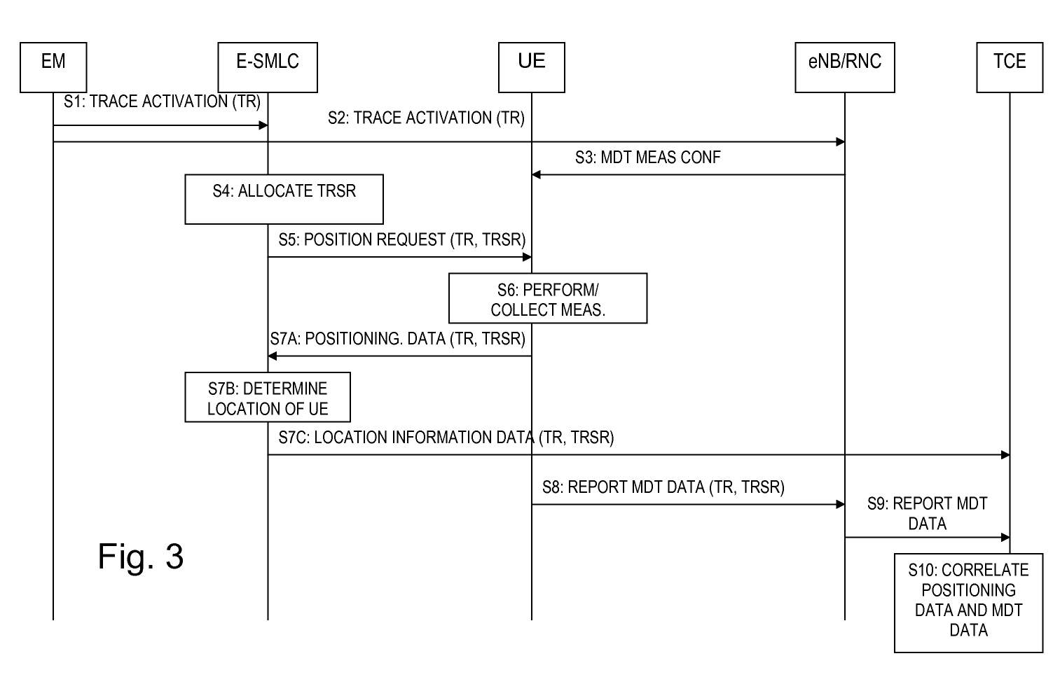

In the following, operations according to embodiments of the present invention are described in some more detail by referring to FIGS. 2 and 3.

FIG. 2 shows a signalling diagram according to a first embodiment.

In process S1, a trace activation request including a trace reference (TR) is sent from a network management element (e.g., EM or the like) to a positioning server (SLMC or E-SLMC), as described above. In step S2, the trace activation request is forwarded to eNB/RNC, which then forwards MDT measurement configuration to the UE in step S3. It is noted that the timely order of processes S1 and S2 could be vice versa, or both processes could be carried out at the same time. In step S4, the E-SLMC establishes a position request for the user equipment (UE) and allocates a trace recording session reference (TRSR) for the positioning request. In process S5, the E-SMLC sends the position request including both TR and TRSR to the user equipment (UE). The UE may be determined based on an IMEI(SV)/IMSI number or MSISDN, as described above.

In process S6, the UE performs measurements, i.e., collects MDT data and the like and also collects positioning data. In process S7, the UE reports to the eNB/RNC the positioning data, and in process S8, the UE reports MDT data to eNB/RNC.

In process S9 eNB/RNC forwards the positioning data and the MDT data to the centralized trace collection entity (TCE). It is noted that in process S9, the positioning data and the MDT data may be sent separately from the eNB/RNC to the TCE. The reports as sent in processes S7, S8 and S9 contain TR and

TRSR. It is noted that the timely order of processes S7 and S8 could be vice versa, or both processes could be carried out at the same time.

Thus, in process S10, the TCE can correlate the positioning data and the MDT data based on the trace reference (TR) and the trace recording session reference (TSRS) parameters.

FIG. 3 shows a signalling diagram according to a second embodiment, which differs from the first embodiment in that the E-SMLC determines the location of the UE. In particular, in process S7A, the UE sends the positioning data including TR and TRSR to the E-SLMC, in step S7B the E-SLMC determines the location of the UE based on the positioning data received from the UE, and in step S7C, the E-SLMC sends location information for the UE to the centralized trace collection entity (TCE). Otherwise, the processes are the same as according to the first embodiment.

In this way, according to the second embodiment, the E-SMLC calculates final UE position in order to relieve the responsibility of the UE and to provide reliable positioning on time.

Thus, summarizing, according to the embodiments above, when positioning server initiates the positioning request to the mobile, it sends the trace reference (TR) and allocates a trace recording session reference (TRSR). The UE will send the TR and TRSR in the positioning data and in the MDT data, so that the positioning data and the MDT data can easily be correlated.

Hence, according to embodiments of the present invention, the results of the measurements can easily be handled. Namely, it is simpler and faster to compare an identifier (ID) such as TR and/or TRSR to correlate the MDT measurements with the position information than to compare the time of collection of MDT measurements and timestamp associated with the position information.

As described above, basically, the SMLC or E-SMLC gets involved as an independent procedure to acquire position data. The SMLC or E-SMLC receives the trace reference, and by combining the reference and position data, and the reference and MDT data, the position of the trace can be defined.

Hence, according to embodiments of the present invention, a fast and easy correlation possibility for the positioning data and MDT data is created, instead of having the comparison of timestamps.

That is, embodiments of the present invention describe a way how to correlate the positioning data received in LTE Positioning Protocol LPP and the MDT report received in radio resource control (RRC) in a fast an efficient way.

It is noted that some embodiments as described above are directed to LTE or LTE-A. However, LTE or LTE-A is only an example, and embodiments of the present invention may be applied on any radio access technology in which a measurement (e.g., concerning the condition in a network and/or coverage of the network) is carried out, in which also the location of mobile terminal carrying out corresponding measurements has to be known.

According to a first aspect of several embodiments of the invention, an apparatus is provided which comprises
a receiver configured to receive a position request including a trace session identification parameter (e.g., TR and/or TRSR as described above),
a controller configured to perform positioning of the apparatus and to collect measurement (e.g., MDT) data in response to the received position request including the trace session identification parameter, and
a sender configured to send the measurement data and positioning data including the trace session identification parameter.

The first aspect may be modified as follows:

The controller may be configured to determine a location of the apparatus and to include information about the location into the positioning data.

The trace session identification parameter may further include a trace recording session identification parameter.

The sender may be configured to send the measurement data and the positioning data including the trace session identification parameter to a network control element (e.g., TCE as described above).

The sender may be configured to send the measurement data including the trace session identification parameter to a network control element and to send the positioning data including the trace session identification parameter to a positioning server.

According to a second aspect of several embodiments of the invention, an apparatus is provided which comprises
a receiver configured to receive a trace activation request including a trace session identification parameter,
a controller configured to generate a position request for a mobile terminal, and
a sender configured to send the position request to the mobile terminal with the trace session identification parameter.

The second aspect may be modified as follows:

The controller may be configured to allocate a trace recording session parameter within a trace session, and
the sender may be configured to send the position request to the mobile terminal with the trace session identification parameter and the trace recording session identification parameter.

The controller may be configured to identify the mobile terminal based on an identifier (e.g., IMEI/MSISDN) of the mobile terminal.

The receiver may be configured to receive positioning data including the trace session identification parameter from the mobile terminal,
the controller may be configured to determine the location of the mobile terminal based on the positioning data, and
the sender may be configured to send information including information about the location of the mobile network node and the trace session identification parameter to a network control element.

According to a third aspect of several embodiments of the invention, an apparatus is provided which comprises
a receiver configured to receive position information data comprising a trace session identification parameter, the position information data including information about the position of a mobile terminal, and measurement data comprising the trace session identification parameter, and
a controller configured to correlate the position information data with the measurement data based on the trace session identification parameter.

The third aspect may be modified such that the receiver may be configured to receive position information data comprising the trace session identification parameter from the mobile terminal or from a positioning server.

According to a fourth aspect of several embodiments of the invention, an apparatus is provided which comprises
a controller configured to generate a trace session activation request for a mobile terminal based measurement data collection, and
a sender configured to send the trace session activation request including a trace session identification parameter to a positioning server.

In the above aspects, the trace session identification parameter may further include a trace recording session identification parameter.

According to a fifth aspect of several embodiments of the invention, a method is provided which comprises
receiving a position request including a trace session identification parameter,
performing positioning of a mobile terminal and collecting measurement data in response to the received position request including the measurement identification parameter, and
sending the measurement data and positioning data including the trace session identification parameter(s).

The fifth aspect may be modified as follows:

The method according to the fifth aspect may be carried out in the mobile terminal, for example.

The method may further comprise determining a location of the apparatus and including information about the location into the positioning data.

The trace session identification parameter may further include a trace recording session identification parameter.

The sending may comprise sending the measurement data and the positioning data including the trace session identification parameter to a network control element.

The sending may comprise sending the measurement data including the trace session identification parameter to a network control element and sending the positioning data including the trace session identification parameter to a positioning server.

According to a sixth aspect of several embodiments of the invention, a method is provided which comprises
receiving a trace activation request including a trace session identification parameter,
generating a position request for a mobile terminal, and
sending the position request to the mobile terminal with the trace session identification parameter.

The sixth aspect may be modified as follows:

The method according to the sixth aspect may be carried out in a positioning server.

The method may further comprise
allocating a trace recording session parameter within a trace session, and
sending the position request to the mobile terminal with the trace session identification parameter and the trace recording session identification parameter.

The method may further comprise identifying the mobile terminal based on an identifier of the mobile terminal.

The method may further comprise
receiving positioning data including the trace session identification parameter from the mobile terminal,
determining the location of the mobile terminal based on the positioning data, and
sending information including information about the location of the mobile terminal and the trace session identification parameter to a network control element.

According to a seventh aspect of several embodiments of the invention, a method is provided which comprises
receiving position information data comprising a trace session identification parameter, the position information data including information about the position of a mobile terminal, and measurement data comprising the trace session identification parameter, and
correlating the position information data with the measurement data based on the trace session identification parameter.

The seventh aspect may be modified as follows:

The method may be carried out by a network control element (e.g., a trace collection entity)

The method may further comprise
receiving position information data comprising the trace session identification parameter from the mobile terminal or from a positioning server.

According to an eighth aspect of several embodiments of the invention, a method is provided which comprises
generating a trace session activation request for collecting mobile terminal based measurement data, and sending the trace session activation request including a trace session identification parameter to a positioning server.

The method according to the eight aspect may be carried out by a network control element (e.g., a domain manager or an element manager).

In the above aspects, the trace session identification parameter may further include a trace recording session identification parameter.

According to a ninth aspect of several embodiments of the present invention, a computer program product is provided which comprises code means for performing a method according to any one of the second aspect and its modifications when run on a computer, a processing means or module.

The computer program product may be embodied on a computer-readable medium.

According to a tenth aspect of several embodiments of the invention, an apparatus is provided which comprises
means for receiving a position request including a trace session identification parameter,
means for performing positioning of the apparatus and to collect measurement data in response to the received position request including the trace session identification parameter, and
means for sending the measurement data and positioning data including the trace session identification parameter.

The tenth aspect may be modified as follows:

The apparatus may further comprise means for determining a location of the apparatus and means for including information about the location into the positioning data.

The apparatus may further comprise means for sending the measurement data and the positioning data including the trace session identification parameter to a network control element.

The apparatus may further comprise means for sending the measurement data including the trace session identification parameter to a network control element and for sending the positioning data including the trace session identification parameter to a positioning server.

According to an eleventh aspect of several embodiments of the invention, an apparatus is provided which comprises
means for receiving a trace activation request including a trace session identification parameter,
means for generating a position request for a mobile terminal, and
means for sending the position request to the mobile terminal with the trace session identification parameter.

The eleventh aspect may be modified as follows:

The apparatus may further comprise means for allocating a trace recording session parameter within a trace session, and
means for sending the position request to the mobile terminal with the trace session identification parameter and the trace recording session identification parameter.

The apparatus may further comprise means for identifying the mobile terminal based on an identifier of the mobile terminal.

The apparatus may further comprise means for receiving positioning data including the trace session identification parameter from the mobile terminal,
means for determining the location of the mobile terminal based on the positioning data, and
means for sending information including information about the location of the mobile network node and the trace session identification parameter to a network control element.

According to a twelfth aspect of several embodiments of the invention, an apparatus is provided which comprises
means for receiving position information data comprising a trace session identification parameter, the position information data including information about the position of a mobile terminal, and measurement data comprising the trace session identification parameter, and
means for correlating the position information data with the measurement data based on the trace session identification parameter.

The apparatus according to the third aspect may further comprise means for receiving position information data comprising the trace session identification parameter from the mobile terminal or from a positioning server.

According to a thirteenth aspect of several embodiments of the invention, an apparatus is provided which comprises
means for generating a trace session activation request for a mobile terminal based measurement data collection, and
means for sending the trace session activation request including a trace session identification parameter to a positioning server.

Further modifications to the ninth to thirteenth aspects may be similar as those for the first to fourth aspects.

In all aspects, the trace session identification parameter may contain one trace session identification parameter or a plurality of trace session identification parameters.

It is to be understood that any of the above modifications can be applied singly or in combination to the respective aspects and/or embodiments to which they refer, unless they are explicitly stated as excluding alternatives.

For the purpose of the present invention as described herein above, it should be noted that
method steps likely to be implemented as software code portions and being run using a processor at a network element or terminal (as examples of devices, apparatuses and/or modules thereof, or as examples of entities including apparatuses and/or modules therefore), are software code independent and can be specified using any known or future developed programming language as long as the functionality defined by the method steps is preserved;
generally, any method step is suitable to be implemented as software or by hardware without changing the idea of the invention in terms of the functionality implemented;
method steps and/or devices, units or means likely to be implemented as hardware components at the above-defined apparatuses, or any module(s) thereof, (e.g., devices carrying out the functions of the apparatuses according to the embodiments as described above, UE, eNode-B etc. as described above) are hardware independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components;
devices, units or means (e.g. the above-defined apparatuses, or any one of their respective means) can be implemented as individual devices, units or means, but this does not exclude that they are implemented in a distributed fashion throughout the system, as long as the functionality of the device, unit or means is preserved;
an apparatus may be represented by a semiconductor chip, a chipset, or a (hardware) module comprising such chip or chipset; this, however, does not exclude the possibility that a functionality of an apparatus or module, instead of being hardware implemented, be implemented as software in a (software) module such as a computer program or a computer program product comprising executable software code portions for execution/being run on a processor;
a device may be regarded as an apparatus or as an assembly of more than one apparatus, whether functionally in cooperation with each other or functionally independently of each other but in a same device housing, for example.

It is noted that the embodiments and examples described above are provided for illustrative purposes only and are in no way intended that the present invention is restricted thereto. Rather, it is the intention that all variations and modifications be included which fall within the spirit and scope of the appended claims.

1. An apparatus comprising
a receiver configured to receive a position request including a trace session identification parameter,
a controller configured to perform positioning of the apparatus and to collect measurement data in response to the received position request including the trace session identification parameter, and
a sender configured to send the measurement data and positioning data including the trace session identification parameter.

2. The apparatus according to claim 1, wherein the controller is configured to determine a location of the apparatus and to include information about the location into the positioning data.

3. The apparatus according to claim 1, wherein the trace session identification parameter further includes a trace recording session identification parameter.

4. The apparatus according to claim 1, wherein
the sender is configured to send the measurement data and the positioning data including the trace session identification parameter to a network control element.

5. The apparatus according to claim 1, wherein
the sender is configured to send the measurement data including the trace session identification parameter to a network control element and to send the positioning data including the trace session identification parameter to a positioning server.

6. (canceled)

7. (canceled)

8. (canceled)

9. (canceled)

10. An apparatus comprising
a receiver configured to receive position information data comprising a trace session identification parameter, the position information data including information about the position of a mobile terminal, and measurement data comprising the trace session identification parameter, and
a controller configured to correlate the position information data with the measurement data based on the trace session identification parameter.

11. The apparatus according to claim 10, wherein the receiver is configured to receive position information data comprising the trace session identification parameter from the mobile terminal or from a positioning server.

12. (canceled)

13. The apparatus according to claim 10, wherein the trace session identification parameter further includes a trace recording session identification parameter.

14. A method comprising
receiving a position request including a trace session identification parameter, performing positioning of a mobile terminal and
collecting measurement data in response to the received position request including the measurement identification parameter, and
sending the measurement data and positioning data including the trace session identification parameter.

15. The method according to claim 14, further comprising determining a location of the apparatus and including information about the location into the positioning data.

16. The method according to claim 14, wherein the trace session identification parameter further includes a trace recording session identification parameter.

17. The method according to claim 14, wherein
the sending comprises sending the measurement data and the positioning data including the trace session identification parameter to a network control element.

18. The method according to claim 14, wherein
the sending comprises sending the measurement data including the trace session identification parameter to a network control element and sending the positioning data including the trace session identification parameter to a positioning server.

19. (canceled)

20. (canceled)

21. (canceled)

22. (canceled)

23. A method comprising
receiving position information data comprising a trace session identification parameter, the position information data including information about the position of a mobile terminal, and measurement data comprising the trace session identification parameter, and
correlating the position information data with the measurement data based on the trace session identification parameter.

24. The method according to claim 23, further comprising
receiving position information data comprising the trace session identification parameter from the mobile terminal or from a positioning server.

25. (canceled)

26. The method according to claim 23, wherein the trace session identification parameter further includes a trace recording session identification parameter.

27. (canceled)

28. (canceled)
